(19) United States
(12) Patent Application Publication
(10) Pub. No.: US 2006/0059745 A1
(43) Pub. Date: Mar. 23, 2006

(54) Digital display and message device

(76) Inventors: David Maqui, Encino, CA (US); Sean Taheri, Encino, CA (US)

Correspondence Address: Colin P. Abrahams;Suite 400, 5850 Canoga Avenue, Woodland Hills, CA, 91367, US

(21) Appl. No.: 11/191,707

(22) Filed: Jul. 27, 2005

Related U.S. Application Data
(63) Continuation-in-part of application No. 11/116,615, filed on Apr. 28, 2005.
Application No. 11/116,615 is a continuation of application No. 10/397,707, filed on Mar. 26, 2003, now abandoned.

(51) Int. Cl. G09F 21/04

(52) U.S. Cl. 40/591

(57) ABSTRACT

A digital message and display device for use on a vehicle, structure or personal item comprises a processing unit including a memory storage device for location in the vehicle. A power connector connects the processing unit to a source of power. A data input mechanism is provided for inputting data comprising text and/or images to the memory storage device. A display screen located on or in the vehicle then displays the text and/or images received from the processing unit such that the text and/or images are formed and can be observed as part of the external appearance of the vehicle.

### CROSS REFERENCE TO RELATED APPLICATIONS

This application is a continuation in part application of U.S. patent application Ser. No. 11/116,615 filed Apr. 28, 2005, which is a continuation application of U.S. patent application Ser. No. 10/397,707 filed Mar. 26, 2003, both of which are incorporated herein by reference in their entirety.

### FIELD AND BACKGROUND OF THE INVENTION

This invention relates to digital display and message devices. Particularly, a preferred aspect of the invention relates to digital display and message devices for use on vehicles, although the invention is not limited thereto.

Many drivers of vehicles, including cars, trucks, motor cycles, boats and the like enjoy displaying messages or signs on their vehicles. Such signs may be humorous, set forth an issue on a cause, or convey information about the driver him/herself. Most often, the signs are displayed in the form of bumper stickers, as well as frames for license plates. Other types of display may include cards or posters attached to the inside of windows, such as by suction cups or adhesive, or magnetically attached signs which can be removably connected to the metal body of the vehicle.

In addition, commercial or other vehicles may also have thereon signs relating to business names, products, or simple advertising.

All of the above messages and signs are typically comprised of words or images printed on paper, metal, cardboard, plastic or some other such medium which is then attached to the vehicle in any number of ways.

One drawback of the conventional methods of attaching signs and messages to vehicles is that a particular sign is fixed in the nature of its content and cannot normally be changed. The only way to change a sign is to physically remove the cardboard, plastic, paper etc. medium from the vehicle. This is often a difficult task, and may also leave markings, scratches or different colors resulting from fading. Further, the signs and messages currently used for display on vehicles cannot be updated in real time, and therefore cannot be changed at the whim or fancy of the driver in response to a current situation.

It is therefore an aspect of the present invention to provide different types of message and display devices, which can be digitally updated, changed or canceled on an ongoing basis, without removing or even having to contact the medium upon which the display or message is conveyed.

### SUMMARY OF THE INVENTION

According to one aspect of the invention, there is provided a digital message and display device for use on a vehicle having an interior and an external appearance, the display device comprising: a processing unit including a memory storage device for location in the vehicle; a power connector for connecting the processing unit to a source of power; a data input device for inputting data comprising text and/or images to the memory storage device; and a display screen located on or in the vehicle for displaying the text and/or images received from the processing unit such that the text and/or images are formed and can be observed as part of the external appearance of the vehicle.

In one aspect, the present invention relates to a digital display unit, preferably for use on a vehicle, which can be programmed in different ways, so as to display text, images, or a combination thereof. The digital display is preferably used on vehicles such as cars and trucks, but other vehicles including motor cycles, boats and the like may also be fitted with the display device of the invention. It should also be noted that the display device of the invention is not limited to use on vehicles, but may also be used, for example, around a home entrance for personalized greeting messages, on retail store or restaurant windows for synchronized and simultaneous advertisement, on articles of clothing, on backpacks, and as a portable announcement for use in offices.

In general, the digital display and message device comprises a digital screen or monitor, whose shape, size and dimensions can be appropriately varied according to the location at which it will be installed, as well as the function it will perform, and a processing unit for feeding information to the digital screen. The processing unit is powered by a power source, such as an AC outlet, a DC outlet, batteries, power from a cigarette lighter or some such equivalent. Also associated with the processing unit is a data or message input device, which may take various forms. For example, the input device may comprise a keypad, which may or may not include a preview screen, and/or a microphone and an associated voice recognition system for converting spoken instructions into electronic signals, ultimately converted into a message or image on the screen. Additionally, the input device may comprise a receiver for receiving data input from satellites or wireless transmissions. As mentioned above, the digital screen or monitor is particularly suited and intended for use on a vehicle, although not limited to this application. When used on a vehicle, the digital display screen or monitor may take a number of forms, and be located in a number of different positions in and about the vehicle. For example, a framed digital display or monitor may be positioned inside the vehicle, behind the rear window so that people behind the vehicle will be able to read messages and view images thereon. In another embodiment, the vehicle may be fitted with a special license plate holder or frame which includes a digital screen or monitor for receiving and changing messages. In yet another embodiment, a thin flexible screen can be applied to the rear window, or a side window, for receiving and displaying messages. Such digital screens will, of course, be translucent so that the driver of the vehicle will be able to see through it from inside of the vehicle and so that visibility remains essentially unchanged, and the screen does not pose any safety hazard by blocking the view of the driver.

The digital screen or monitor of the invention may also appear on other types of vehicles, such as motor cycles, boats, aircraft or the like. Additionally, the digital screen may also be placed over a window of a retail establishment, one example of which may be a chain of fast food stores. It is not unusual for such chains to receive posters to be applied to the inside windows of the restaurant on special offers or items on the menu. A digital screen or monitor of the invention, located on the window could be installed as a more or less permanent fixture, and would, of course, have the advantage of being able to show different messages either in series, each message been shown for a short period, or changed after a special offer has expired, which may take a number of weeks. Such an arrangement would have a distinct advantage over paper or other media type posters placed on windows, since it can be updated in real time, and would save printing costs, removal, clean-up and the like.

Another application in which the digital screen or monitor may be used may be in offices or homes, to be placed on windows or other surfaces, to provide greetings or directions to persons visiting the home or office.

The processing unit of the message device of the invention can, of course, be located remotely from the digital screen or monitor. Information in the form of words or images entered into the central processor, and to be displayed on the monitor, may be transmitted in electronic form between the processing unit and the monitor by hard wiring or by transmitting signals, or by placing appropriate transmitters and receivers on the processing unit and the digital monitor or screen respectively so as to facilitate wireless transfer of signals between such processing unit and the monitor.

While in many instances the processing unit will be proximal to the display screen or monitor, and wired thereto, there may be many situations where the processing unit may be distant, in some cases very distant, from the monitor. For example, and referring to the example above relating to the fast-food chain, signals may be transmitted from corporate headquarters or another location of a company to all of its branches or franchises so that each may simultaneously display similar messages and images. The possibility for variation in such an example is of course significant, so that regional differences in offerings and prices can be accommodated by transmitting the appropriate information to respective stores or outlets, as the case may be.

In a vehicle, which would be a common location for the digital display and massage device of the invention, the processing unit may be hidden or unobtrusively located behind the dashboard, under the seat, or in any other convenient place. The processing unit would be in wired or wireless contact with the monitor, as described above, and also in contact with the input device, so that it could receive and process images and text and transmit them for display on the digital screen or monitor. It is also possible that the processing unit could be placed in the vehicle in a manner which would make it easily portable, so that the device could be used in different vehicles, or different locations, as may be desired by the user. The portability of the processing unit may be such that it is easily used and transported alone, or with the input device and/or the display screen and monitor respectively.

The input device would generally take three different forms, although any convenient manner of inputting data into the system would fall within the scope of the invention. The three most common ways for inputting data would be through an alpha-numeric keypad, a microphone with associated voice recognition capability, or a signal receiver for receiving signals from a remote source or satellite. However, other input devices may also be used. These input devices may comprise memory cards, CD ROMS or other commonly used media for electronically storing and transporting information. The processing unit would, of course, have the appropriate hardware for accepting such media.

The digital display and message device of the invention can be programmed immediately for change, and this will even enable drivers to convey and transmit messages to each other while driving. Further, the screen, in a preferred embodiment of the invention, not only allows for the display of text, but also displays images and pictures. The immediate programming capabilities also allows the use of the digital display and message device of the invention for commercial advertisements, and similar messages and advertisements can be simultaneous and synchronized in a number of units over a wide area, if programed wirelessly from satellite sources.

Another important feature is that the digital display and message device can be used for safety and traffic control and regulation, when utilized by local and other officials for public announcements. For example, messages can be conveyed to a specific location for display in vehicles to advise the drivers of such vehicles, as well as surrounding vehicles, of freeway conditions, including any accidents or other hazards. With this information, drivers can make alternative route decisions, or can even be guided to alternative routes which are open or free of traffic, so that optimal use of freeway and roads can be achieved to benefit a large number of drivers.

Some other applications of the invention include displays on backpacks, and on or around home entrances to provide personalized greeting messages or instructions to visitors.

### BRIEF DESCRIPTION OF THE DRAWINGS

FIG. 1 is a perspective view of a vehicle including the display and message device of the invention shown as a license plate, and an enlarged schematic view of the license plate;

FIG. 2 is a schematic representation showing the components of the device, and the operation thereof;

FIG. 3 is an alterative embodiment of the invention with the display and message device mounted on the trunk of the vehicle;

FIG. 4 shows another embodiment of a schematic representation showing the components and function of the device;

FIG. 5 is a further embodiment of the invention showing the digital screen or monitor located in a vehicle behind the rear window thereof; and

FIG. 6 is yet a further embodiment of the invention with the digital screen or monitor of the device being applied to the rear or side windows of a vehicle;

FIG. 7 is a perspective view of a belt having a buckle with a display device in accordance with the present invention;

FIG. 8 is a front view of a T-shirt including a digital display device in accordance with the present invention;

FIGS. 9, 10 and 11 show various views of a backpack, briefcase and purse, respectively, incorporating a digital display device in accordance with the present invention;

FIGS. 12(a) and 12(b) are front and rear views respectively of a jacket incorporating a digital display device both on the front and rear in accordance with the present invention;

FIG. 13 is a front view of a pair of pants incorporating a digital screen/display device in accordance with the present invention; and

FIG. 14 is a perspective view of a cap including a digital display device in accordance with the present invention.

### DETAILED DESCRIPTION OF THE INVENTION

In general, the invention comprises a digital display and message device having several components. The first is a digital screen or monitor which can be positioned at a desired location, and which is capable of receiving and displaying text messages and/or images. The screen or monitor may be any such device conventionally used and currently known, including computer and TV type monitors, flat screen, plasma displays, LCD screens, and any such other screen which may be capable of displaying appropriate messages. Another critical component of the display and message device is the processing unit, preferably contained within a housing, and connected by hard wire or wireless remote to the screen so that predetermined or desired text and images can be transmitted from the processing unit to the screen for display thereon. The central processing unit may comprise any suitable electronic circuit board, which would or course include means for receiving an inputted signal, processing the signal in electronic format in a manner which can be transmitted and displayed on a screen, and a hard wire or wireless connection to the monitor for transmitting the desired signals. The processing unit may, as will be described, include a voice activation module or system for recognizing spoken words, and converting them into electronic and digital format which can be used by the system. Further, the processing unit may comprise antennae, infra-red receivers and transmitters, and other appropriate hardware to enable it to function in a manner contemplated by the invention.

The processing unit may also comprise appropriate software to enable the user to edit, amend, merge, or otherwise vary the message, using conventional or otherwise available software applications to facilitate such input and change.

The processing unit can be powered in a number of ways, and the particular power source for a specific display and message device of the invention will, in large part, be dictated by its location and function. Thus, for display and message devices for use in vehicles, the device of the invention would obviously be configured so as to tap into the vehicle's power system. Thus, the device of the invention may connect to a battery, or any appropriate outlet, such as a cigarette lighter, or power output device now common in many vehicles. Of course, the system may carry its own portable power pack, including disposable or rechargeable batteries. These batteries may be used as the main power source, or as a back-up if other sources of power fail.

The other major component of he invention is the system for inputting data to the processing unit for ultimate display on the screen. As mentioned above, three common forms of input device are contemplated, and these are an alpha-numeric keypad, a microphone with associated voice recognition system, and a signal receiver for detecting and receiving electronic signals transmitted via satellite or other wireless modes. The input device, whether fed with information from any of the above three sources, or such other sources including memory cards and discs, may include a screen upon which the message can be previewed. Where the appropriate software is provided within the system, the user will have the opportunity to make changes to the message, as desired.

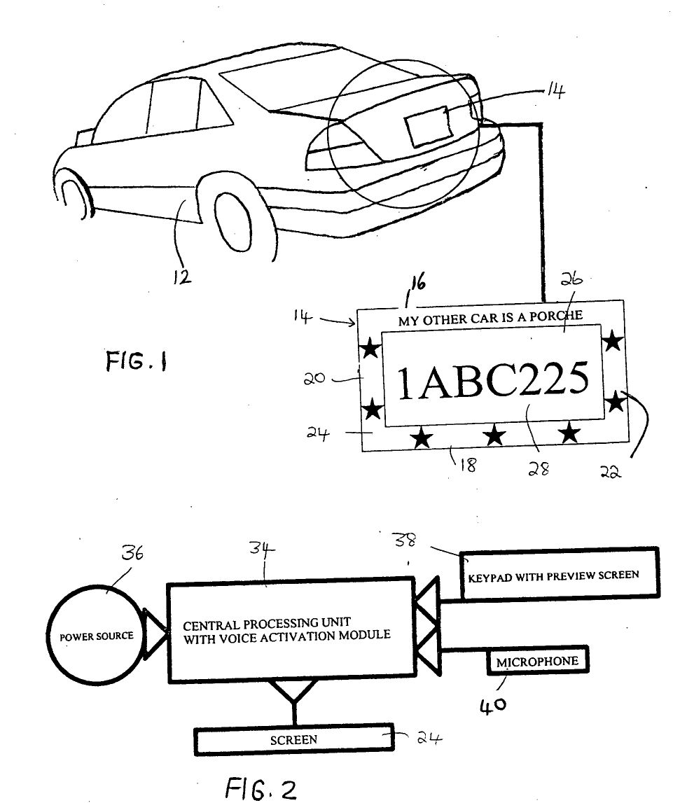

With reference to FIG. 1 of the drawings, there is shown in outline a vehicle 12, including the digital display and message device of the invention. In this particular embodiment, the digital screen or monitor comprises a license plate frame 14 located on the trunk at the rear of the vehicle. FIG. 1 shows an enlarged representation of the license frame 14, to facilitate understanding of the invention.

The license plate frame 14 is substantially rectangular in shape, including an upper section 16, a lower section 18, a left side section 20 and a right side section 22. The licence plate frame 14 has a front surface 24 on each of the sections 16, 18, 20 and 22, the front surface 24 having a digital screen or display area for displaying predetermined text and images, received from a processing unit.

The license plate frame defines an open space 26, and the license plate 28 is mounted behind the license plate frame 14, so that the license plate number, state, as well as registration and renewal tokens, can be shown and viewed through the open space 26.

It-should be noted, however, that in another embodiment, it is possible that the open space 26 may comprise part of the display screen so that the license plate number, as well as the state registration and other information, can be displayed thereon. Such an arrangement would, of course, require authorization and approval by various state Departments of Motor Vehicles, so that the digital display of vehicle information may be only a future practical application of the invention. However, it is certainly within the scope and capability of the invention to incorporate such displays.

In the particular embodiment shown in FIG. 1 of the drawings, and with particular reference to the license plate frame 14, the upper section 16 shows a message “MY OTHER CAR IS A PORSCHE”. This is a message which has been programmed and transmitted to the front surface screen 24. The side sections 20 and 22, as well as the lower section 18 both display a plurality of stars. It will, of course, be appreciated that both the message and the image can be changed at will by the user. The message and image in FIG. 1 is merely one of an infinite number of examples, and is intended to convey the attribute of the invention that many message texts and images can be displayed.

The front surface 24, including the display screen, would, in practice, include protective coatings and materials so that the digital display would not be damaged by rain, solid debris, or other reasonable hazards normally encountered in driving a vehicle.

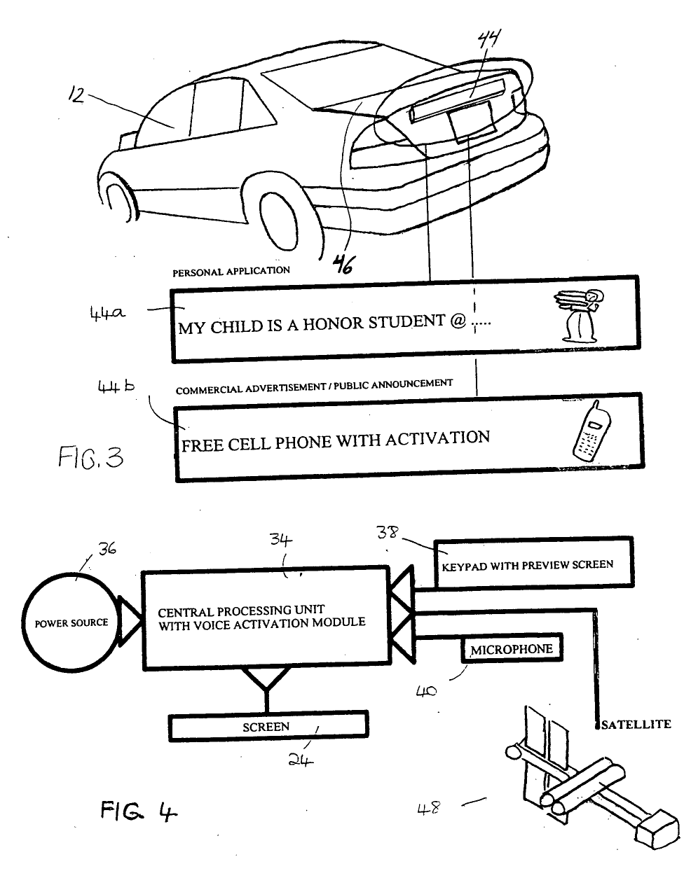

FIG. 2 of the drawings shows a schematic representation of the digital display and message device of the invention- In FIG. 2, the screen 24 represents the digital display portion of the licence plate frame 14 shown in FIG. 1 of the drawings. The screen 24 is connected to a processing unit 34, which, in many instances, will be located within the vehicle. The processing unit 34 may be easily plugged into the various components to which it attaches so that it can be portable and removed. Otherwise, the processing unit can be permanently secured and hidden within a convenient location in the car, if it is intended to remain in the vehicle on a long-term basis. The processing unit 34 includes the necessary electronic hardware for carrying out the operation and function of the invention, as is described in this specification.

The system is supplied with power from a power source 36 which would normally connect to the central processing unit 24. As already mentioned, the power source can be any one of a number of devices within the vehicle.

The processing unit 34 receives information from input devices. In FIG. 2 of the drawings, two input devices are shown, namely, a key pad with a preview screen 38, and a microphone 40. It will be appreciated that the processing unit 34 may have one or several input devices. This would depend upon the requirements and nature of the application of the invention. However, for convenience, a typical message display device of he invention would have several input mechanisms. FIG. 2 shows two of these.

The keypad 38 typically comprises an alpha-numeric keyboard, and may further include additional keys with other functions. The keypad would have the ability to draw on stored images within the processing unit 34 so that these can be selected and programed for display. For example, the user may wish to display the image on the screen of an American flag. Using the keypad, the user would access memory storage within the processing unit, preferably by category, such as “flags”, and within this category file, select the desired flag for display, in this case, the American flag. The memory storage within the processing unit may comprise a large number of categories, and the number of images can be expanded upon and stored within the system depending upon the desires of the user. Furthermore, if the processing unit 34 and input devices are sufficiently sophisticated, the user may compose his/her own images for storage and optional display.

Another input device illustrated in FIG. 2 of the drawings is the microphone, and this may be a preferred form of input for use by a driver, since it requires the least effort and minimal distraction from concentration for driving. The system may include a microphone 40 mounted, for example, on the steering wheel or column, the sun visor in front of the driver, or any other convenient location, so that it can be activated by the driver who can speak words and instructions into the system which will be recognized with appropriate voice recognition software. At present, such software varies widely from that which is capable of receiving and understanding a very limited number of words and instructions, to much more sophisticated systems with much larger data bases and the capability of recognizing a multitude of words and instructions. Often, these more sophisticated systems require “training” in order to become adept at recognizing specific accents and word usage by the user. While the invention contemplates the use of both simple and sophisticated voice recognition systems, and anything in between, it is not limited to any one type of system. The importance of the voice recognition at this time should be understood as being simply that commands, instructions and words can be inputted and received by the processing unit, processed thereby and displayed on the screen.

As will be appreciated from the above description, the user provides input to the processing unit by typing in text or image commands with the keypad 38, which may be previewed on the screen. Alternatively, or in addition, information may be inputted through microphone 40, wherein spoken instructions are processed by a voice recognition system in the processing unit. In either event, a desired image or text is constituted for display on the screen, and this is electronically transmitted through appropriate wiring, infra-rad technology transfer or other wireless systems to the screen, where it is configured in the form of the text and image which is readable to viewers. The image will remain on the screen for as long as desired. The processing unit may have default systems, and the message may be displayed for a limited time, at predetermined times, or only while the vehicle is in operation. In other versions, certain messages can be displayed while the vehicle is not in operation, such as broken down on the side of the road, where an appropriate message to alert passing vehicles may be displayed. It will be appreciate that the timing and display times of the message can vary and the system is designed to accommodate these requirements.

Reference is now made to FIG. 3 of the drawings, which shows the vehicle 12 having a display screen or monitor 44 mounted on the trunk 46 of the vehicle. The display 44 may be permanently bolted and affixed to the trunk 46, or it may have some intermediate-type of attachment which enables it to be released and/or removed.

The display 44 shown in FIG. 3 of the drawings exemplifies two different types of messages which can be shown. In the display 44a, a personal message such as “MY CHILD IS AN HONOR STUDENT AT . . . ”, together with an image icon of a child holding books, can be displayed. In the display 44b, a commercial advertisement is shown for, for example, a cell phone, together with an image icon showing a cell phone. Although not shown, yet a third type of message, in the form a public announcement, may be formed on the display 44. Such a message may relate to police activity ahead, an accident on the freeway, adverse weather conditions, detours or constructions areas, and the like. It should be understood that there is no limit to the number of displays which can be shown on the device. Moreover, the nature of the device enables it to alternate between different types of messages. For example, a driver may announce, in different signals, achievements of different children. Moreover, personal announcements may be alternated with commercials or public announcements.

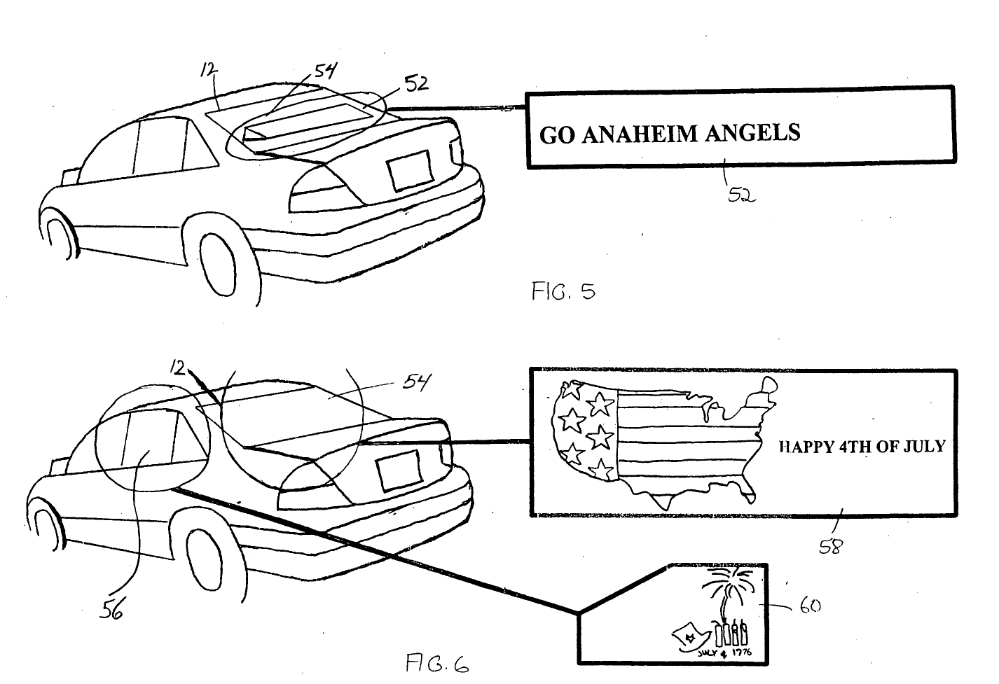

FIG. 4 illustrates a schematic representation showing the function and components of the system. It will be appreciated that the representation shown in FIG. 4 is in most respects identical to that shown in FIG. 2. Common elements of the system will not be described in further detail at this point. However, it is to be noted that FIG. 4 shows an additional input device comprising a satellite signal receiver 48 for receiving satellite signals which would transmit information at predetermined frequencies which can be received by antennae and associated electronic equipment within the processing unit 34. The ability to receive signals from outside sources enables the message display device of the invention to be used both as an advertising medium, as well as for public announcements of the type described above.

With reference to FIG. 5 of the drawings, another embodiment of the message display device of the invention can be seen. In this case, a vehicle 12 has mounted behind the rear seat surface a screen 52 so that the display messages on the screen 52 can be observed and read through the rear window 54 of the vehicle. An enlargement of the display 52 is shown, in this case incorporating a sports-related message and accompanying icon. Other than the specific form of the display and its location, the components of the display device of the invention are otherwise substantially similar to those which have been described above.

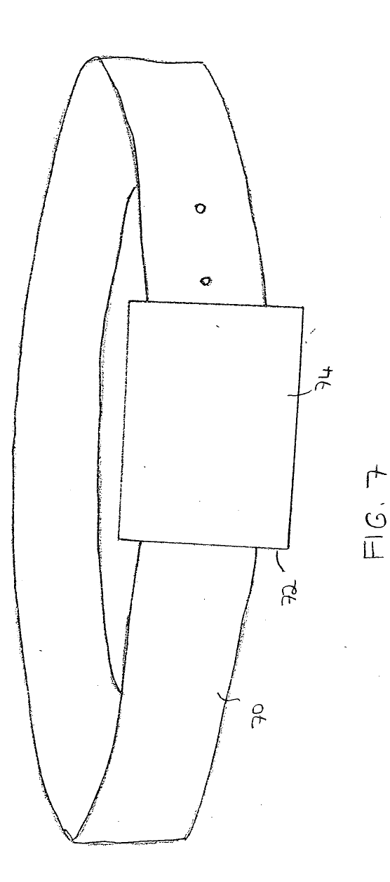

FIG. 6 of the drawings shows yet another embodiment of the invention. In this case, instead of a solid frame, boxed display, or other type of unit, the screen comprises a thin plastic device which is applied to the inside of a window within the vehicle. Preferably, this device would be applied to the inside of the rear window 54, or a side window 56. The screen display, shown by reference numerals 58 and 60 for the rear window and side window respectively, would be capable of receiving and displaying messages including images and text from the processing unit. However, the type of screen shown in FIG. 6 of the drawings is sufficiently thin, and the message displayed sufficiently translucent, so that the driver operating the vehicle will not have his field of vision obscured or otherwise compromised by placement of the screens. The message would, nevertheless, be visible to those outside of the vehicle. It may well be that the images displayed on such screens are not as vibrant and full as some of the screen devices described above, but they are, notwithstanding, able to display readable messages. These are shown in FIG. 6 as being, for example, an American flag in the shape of the United States, with the text “HAPPY 4^{TH} OF JULY” in the rear window, and some fireworks representations and text for the side window 60.

As has been emphasized above, the present invention has a particularly advantageous application when used on vehicles, especially cars and trucks, since the system is potentially able to display an infinite number of messages for as long as the user desires, as well as to offer a new advertising medium and an outlet for important public-service messages which may relate to hazards and safety conditions. The system therefore has the potential to reach large numbers of people, and can serve not only as an important commercial and news dispersal tool, but also as a more lighthearted mechanism for conveying messages of a personal nature.

When used with a satellite receiving kit, the message display system of the invention can display messages which are specific and relevant to only a limited geographical area. Thus, satellite transmissions can target vehicles with appropriate receivers in a given area to warn on driving conditions, anticipated weather changes and the like, without bothering users and viewers for whom such information has no relevance.

The invention may also may used, for example, in retail outlets, Thus, a screen of appropriate size and dimensions may be mounted on the window of, for example, a fast food outlet. Satellite transmissions may have similar messages which can be varied and interspersed with other messages, for all related fast-food outlets in a particular chain, and located in a specific geographical area. The processing unit would be located within the outlet, and have satellite transmission receiving means for receiving updated images and text which may be displayed in a manner similar to poster displays conventionally seen on such windows. Not only is such a display capable of frequent changes, but a one-time installation of the screen renders unnecessary subsequent adhering of posters and their removal, which can be time consuming and messy.

The device of the invention can also be used on backpacks, clothing, houses and offices, as described. Some of these are illustrated in FIGS. 7 to 14 of the drawings, as described in further detail below.

In FIG. 7 of the drawings, there is shown a belt 70 comprising and including a conventional buckle 72. The buckle 72 is shown to be of generally rectangular shape, and has mounted thereon a display screen 74. The display screen 74 provides information, graphics and the like, as has generally been described above. Further, the display screen 74 may be in contact with the necessary hardware and software, which may be mounted on the buckle 72, some other part of the belt 70, or be worn by the user of the belt 70 in a pocket, or other suitable place, and connected to the display screen 74, either by wire or wirelessly.

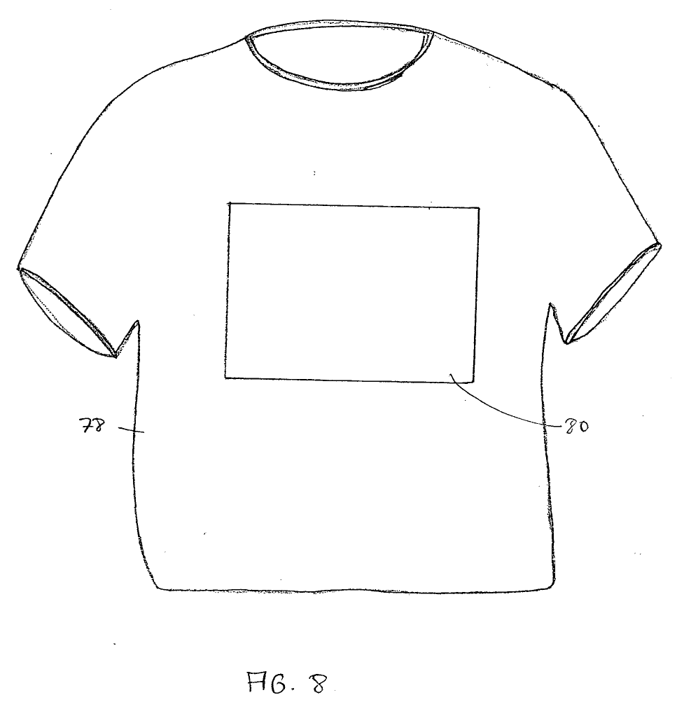

FIG. 8 of the drawings shows a T-shirt 78 having a large rectangular display screen 80 mounted on the front. In FIG. 8 the display 80 is shown mounted in the front, approximately centered, but this is an example only, and it may in fact be mounted at any particular location, including, for example, the sleeve of the T-shirt 78. The display screen 80, as is the case with other embodiments shown herein, is preferably in the form of a thin film, and will therefore have some flexibility with the fabric upon which it is mounted. Furthermore, the display screen in FIG. 8 is connected either wirelessly or through appropriate wiring to the hardware and software from which information, graphics and the like are generated and displayed on the display screen 80. The hardware may also include appropriate antennae and/or receiving means for receiving information and data from a remote source, not connected to the hardware or software.

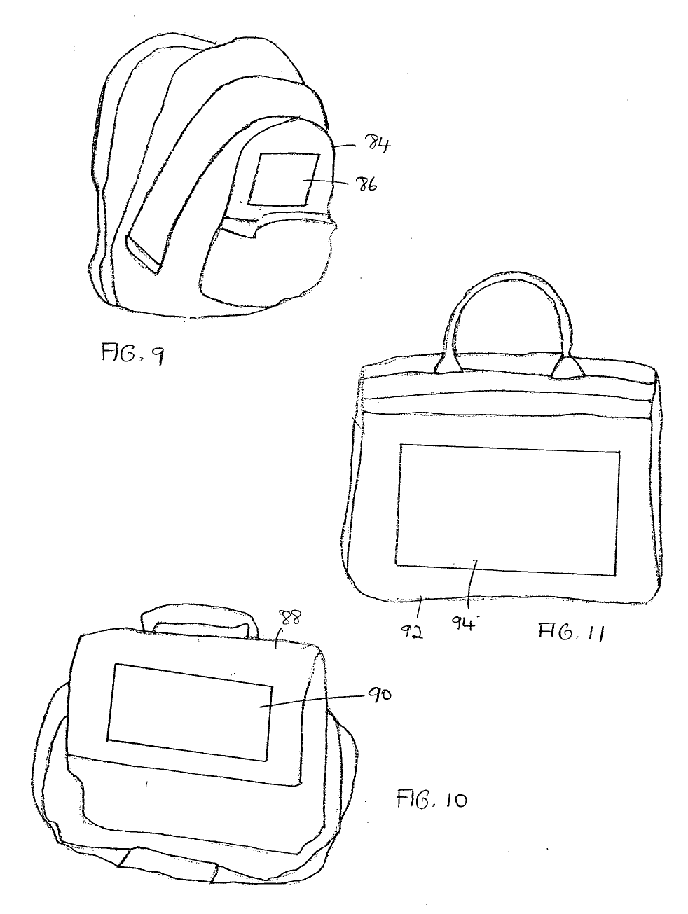

Reference is now made to FIGS. 9, 10 and 11 of the drawings. FIG. 9 shows a backpack 84 having a display screen 86 thereon; FIG. 10 shows a briefcase 88 having a display screen 90 thereon, and FIG. 11 shows a purse 92 having a display screen 94 thereon. The display screens 86, 90 and 94 are in accordance with previous disclosures, may be flexible, and connected appropriately through wire, or wirelessly, to the hardware or software providing the information, graphics or other data displayed on the screen. In the embodiments shown in FIGS. 9, 10 and 11, a suitable place for such hardware would obviously be within the backpack, briefcase or purse respectively, which would be the preferred location.

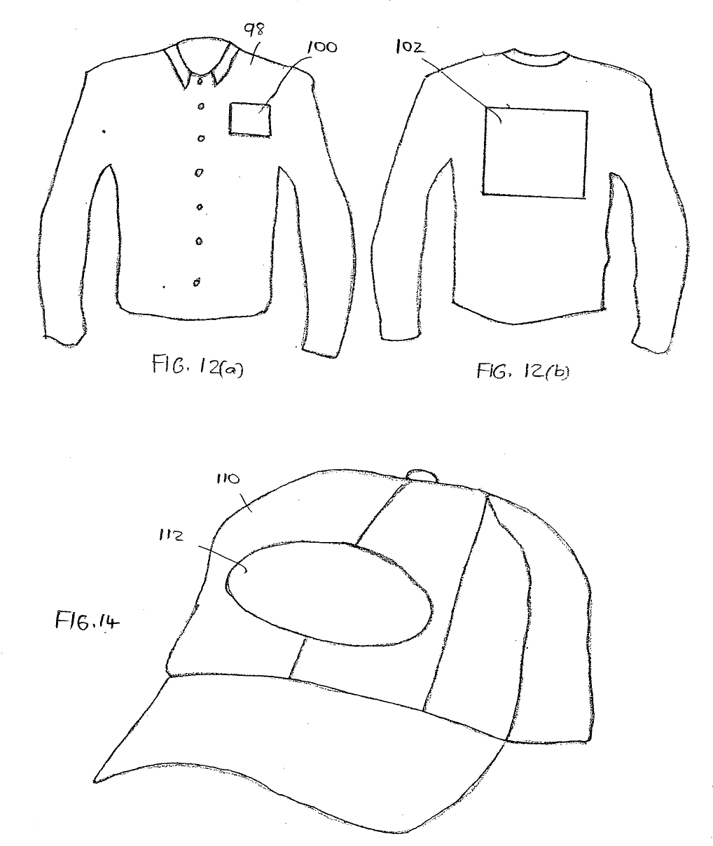

In FIGS. 12(a) and 12(b) of the drawings, there is shown a jacket 98, from the front in FIG. 12(a) and from the rear in FIG. 12(b). In FIG. 12(a), the front of the jacket 98 has a small display screen 100, while, as shown in FIG. 12(b) of the drawings, the back of the jacket 98 has a display screen 102, which, in the example shown, is larger than the display screen 100 shown on the front of the jacket. The display screens 100 and 102 are, as with respect to other embodiments, connected to the appropriate hardware, software, receivers and other electronic components, which may include antennae for wirelessly receiving data from an outside or remote source. The display screens 100 and 102 may display text and graphics which are identical to each other, or they may be of such a nature that each of the display screens 100 and 102 respectively is able to show different information and displays.

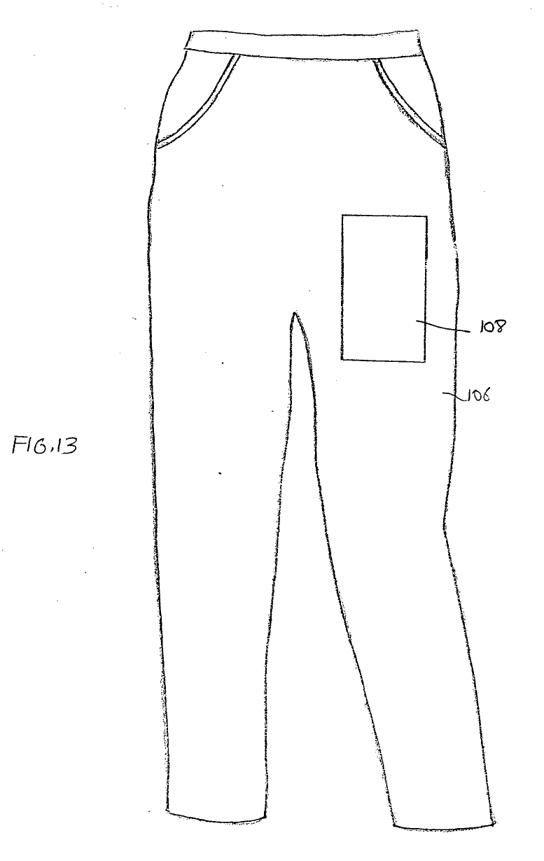

In FIG. 13 of the drawings, there is shown a pair of trousers 106 which has a display screen 108 mounted in the front, approximately over the thigh portion of the pants 106. The display screen is generally of thin film, as with other examples, and appropriately connected for receiving display text and graphics as has heretofore been described.

In FIG. 14 of the drawings, there is shown a cap in accordance with an embodiment of the invention, the cap having the display screen 112 on the front thereof, although of course it may be located in any position on the cap.

As will be seen, the display of the invention can be placed on a large number of different objects, including clothing, purses and the like, so that text and graphic messages may be displayed thereon.

One important application of the invention may be with respect to buses used in a transportation system. Screens may be formed on he windows of a bus, or on some overhead device, and the processing unit may receive signals from outside transmitters so that the location and progress of the bus can be observed by its riders. Alternately, the bus driver may input information through a microphone as the bus trip moves along its route.

As will be appreciated, the invention is not limited to the precise details or specific applications described herein.

1. A digital message and display device for use on a vehicle having an interior and an external appearance, the display device comprising:
a processing unit including a memory storage device for location in the vehicle;
a power connector for connecting the processing unit to a source of power;
a data input device for inputting data comprising text and/or images to the memory storage device; and
a display screen located on or in the vehicle for displaying the text and/or images received from the processing unit such that the text and/or images are formed and can be observed as part of the external appearance of the vehicle.

2. A device as claimed in claim 1 wherein the power source comprises the power system of the vehicle.

3. A device as claimed in claim 1 further comprising a power source for the processing unit.

4. A device as claimed in claim 1 wherein the data input device comprises a keypad.

5. A device as claimed in claim 1 wherein the data input device comprises a microphone and the processing unit includes a voice recognition system for converting voice instructions received in the microphone into electronic or digital form.

6. A device as claimed in claim 1 wherein the data input device comprises satellite signal receiver for receiving signals from a remote satellite transmitter.

7. A device as claimed in claim 1 wherein the data input device is connected to the processing unit by means of an electrical cable.

8. A device as claimed in claim 1 wherein the data input device is connected to the processing unit by means of an infra-red wireless transmitter.

9. A device as claimed in claim 1 wherein the display screen is in the form of a license plate older for mounting on the exterior of the vehicle.

10. A device as claimed in claim 1 wherein the display screen is in the form of a unit for mounting on the trunk the vehicle.

11. A device as claimed in claim 1 wherein the display screen is in the form of a housing for mounting inside of the vehicle behind the rear window thereof.

12. A device as claimed in claim 1 wherein the display screen comprises a thin translucent screen for mounting on the inside of the vehicle window.

13. A device as claimed in claim 1 further comprising a preview screen for previewing the text and/or images prior to display thereof on the display screen.

14. A device as claimed in claim 1 further comprising a memory data base of text and images for selection and display on the display screen.

15. A device as claimed in claim 14 wherein the memory data base can be loaded with additional text and image data.

16. A digital message and display device for use on a structure having an interior and an external appearance, the display device comprising:
a processing unit including a memory storage device for location in or on the structure;
a power connector for connecting the processing unit to a source of power;
a data input device for inputting data comprising text and/or images to the memory storage device; and
a display screen located on or in the structure for displaying the text and/or images received from the processing unit such that the text and/or images are formed and can be observed as part of the external appearance of the structure.

17. A device as claimed in claim 17 wherein the data input device comprises a satellite transmitter.

18. A device as claimed in claim 16 wherein the display screen is selected from a monitor, CD display, plasma screen, or a thin transparent plastic-based screen for adhering to a window on the structure.

19. A device as claimed in claim 16 wherein the display screen is located immediately behind a window of the structure such that the display screen can be seen from the outside of the structure, through said window.

20. A method for displaying a digital message on a vehicle having an interior and an external appearance, the method comprising;
locating a display screen in or on the vehicle such that a message on the display screen is formed and can be viewed as part of the external appearance of the vehicle;
creating a message comprising text and/or images on an input device connected to a processing unit; and
transmitting the message from the processing unit to the display screen.

21. A method as claimed in claim 20 wherein input device is a satellite transmitting the message to the processing unit.

22. A method as claimed in claim 20 wherein the input device is a microphone for inputting spoken words and a voice recognition system is provided for converting the spoken words to form the message.

23. A digital message and display device for use on a personal item, worn or carried by a person, the display device comprising:
a processing unit including a memory storage device for location on connectably associated with the personal item;
a power connector for connecting the processing unit to a source of power;
a data input device for inputting data comprising text and/or images to the memory storage device; and
a display screen located on the personal item for displaying the text and/or images received from the processing unit, such that the text or images are formed and can be observed as part of the external appearance of the personal item.

24. A display device as claimed in claim 23 wherein the personal item is selected from one of the following: belt, shirt, jacket, pants, and cap.

25. A display device as claimed in claim 23 wherein the personal item is one selected from a backpack, briefcase and purse.
